(19) United States
(12) Patent Application Publication
(10) Pub. No.: US 2007/0282859 A1
(43) Pub. Date: Dec. 6, 2007

(54) Method for collecting online visit activity

(75) Inventor: Tom Charvet, San Antonio, TX (US)

Correspondence Address: LOEFFLER JONAS & TUGGEY, LLP, 755 EAST MULBERRY STREET, SUITE 200, SAN ANTONIO, TX, 78212, US

(73) Assignee: CLICK FORENSICS, INC.

(21) Appl. No.: 11/796,031

(22) Filed: Apr. 26, 2007

Related U.S. Application Data
(60) Provisional application No. 60/795,115, filed on Apr. 26, 2006.

(51) Int. Cl. G06F 17/30

(52) U.S. Cl. 707/10; 707/E17.001

(57) ABSTRACT

A method for collecting information provided from a visitor's internet browser and including that information into the log files generated from the originating web server log files. This is achieved by including java, visual basic, and pixel based scripts within an online element such as a web page or web banner. These various types of scripts collect varying amounts of data from the visitor's browser depending on the browser's script execution ability. The data collection process occurs between the visitor's browser and the remote data collection server that hosts the executed scripts. The scripts executed by the visitor's browser can include data not collected from the originating web server. Once the extended data is collected and formed by the remote data collection server the originating web server calls the remote server and combines it with a document such as an image within the online element. When a visitor calls the document the request is logged by the originating web server with the extended data collected by the remote data collection server.

This application is based upon and claims priority from U.S. Provisional application Ser. No. 60/795,115, which is incorporated herein by reference.

### BACKGROUND OF THE INVENTION

1. Field of the Invention

Applicant's invention relates to a method for collecting online visit activity. More particularly it relates to software tools that collect visitor internet browser data and combines it with data collected by the originating web server generated log files.

2. Background Information

A variety of commercially available tools exist that collect visitor internet browser data through the use of scripts contained within an online element. This method returns that data back to the originating web server as to combine the data with the originating web server generated log files.

### SUMMARY OF THE INVENTION

The present invention is directed at a method to combine visitor collected data with data collected by the originating web server. Accordingly, in one aspect of the invention, a method for collecting visitor browser data is provided. The method includes the steps to advantageously combine visitor browser data with web server collected data to provide a unified log file.

The visitor browser based data collection aspect of the invention is an apparatus for extracting and formatting data provided by the visitor's browser through the execution of script located within the online element. The apparatus relates all visitor browser information including, but not limited to, time/date, host IP, referrer, pages viewed, query string parameters, session id, plug-ins, mime types, screen resolution, and user agent.

The combining of visitor browser based data aspect of the invention is an apparatus for appending collected visitor browser data to a document served by the originating web server. These documents types include but are not limited to images, style sheets, and scripts.

While the present invention is not intended to be exclusively controlled by computer programs or algorithms on the Internet, it is intended that the present invention can be implemented and controlled by computer programs or algorithms over the Internet, or other computer network. Therefore, the present invention contemplates a series of computer algorithms and method by which the present invention is implemented and controlled. Thus, in some of the descriptions herein, the present invention is presented partly in terms of process steps and operations of data bits within a computer memory. An algorithm is here, and generally, conceived to be a self-consistent sequence of steps leading to a desired result. These steps are those requiring physical manipulations of physical quantities. In the present invention, the operations referred to may be automated, machine operations done by a computer or similar device performed in conjunction with a human operator.

The present invention relates to the methods for operating such devices, and processing electrical, magnetic, optic, or other physical signals to generate other desired physical signals. It further relates to a computer program and the control logic contained therein. The present invention also relates to apparatus for performing these operations. The apparatus may be specially constructed for the required purposes or it may comprise a general purpose computer selectively controlled or reconfigured by a computer program stored in the memory of the computer. Further, because the present invention is intended to include a network of participants, with no geographic limitations, it is contemplated that to better implement the system of the current invention, at least part of such implementation will take place on the Internet, or other computer network. The method presented herein is not inherently related to any particular computer or other apparatus. Similarly, no particular computer programming language is required. The required structure, although not machine specific, will be apparent from the description herein. Additionally, even though a specific device or software application may, or may not, be mentioned in conjunction with a step, or algorithm, or action, it is intended that any appropriate device or software application necessary or capable of implementing that step, or algorithm, or action is anticipated herein. For example, if a step calls for the input of data, it is contemplated that any appropriate devices such as, but not limited to, various input devices, output devices, data storage devices, data transfers devices, could be used and are anticipated herein.

### BRIEF DESCRIPTION OF THE DRAWINGS

FIG. 1. is a block diagram that illustrates the method from script execution to originating web server logging.

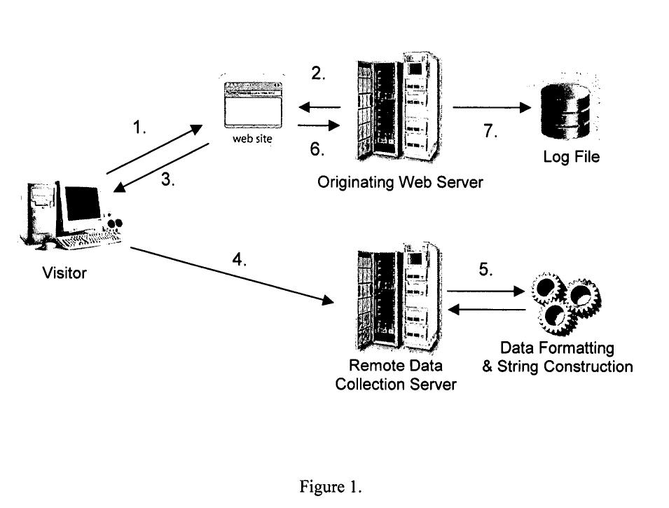

### DETAILED DESCRIPTION OF THE PREFERRED EMBODIMENT

Online Element—A document or file composed of html. Can include but not limited to website pages, banners, and e-mail.

Browser—A program that can view online elements.

Script—A small program embedded in an online element that contacts a remote data collection server to collect and format visitor browser data.

Visitor—The party that engages the client's online elements, including but not limited to visiting client website, clicking client banner, opening a client email.

Originating Web Server—The server that hosts the online elements.

Document Request—Online elements consist of one or more documents. Documents commonly include images and style sheets. During the browser download of an online element the browser requests each document to build and view the online element as a whole.

Include statements—A line of code within an online element that directs the visitor's browser to execute a script not located directly within the online element.

Java Script—general purpose programming language developed by Sun with a number of features that make the language well suited for use on the World Wide Web.

Visual Basic Script—general purpose programming language developed by Microsoft based on event driven and objects oriented methods.

Pixel Based—An image contained within the online element. This image (document) is requested by the visitor's browser and returns visitor browser data back to the server serving the image.

String—A series of characters manipulated as a group.

Variable—A symbol or name that stands for a value.

Data Collection Server—The server that is contacted by the visitor browser and contains the scripts to collect and format visitor browser data.

The method includes the steps of:
a. Visitor requests (1) online element such as web page or web banner. (2)
b. Visitor browser executes scripts within the online element. (3)
c. Visitor browser executed scripts located at remote data collection server. (4)
d. Remote data collection server collects and formats visitor browser data. (5)
e. Visitor requests a document within the online element and the formatted visitor browser data is appended to the request. (6)
f. The originating web server logs the document request with the appended visitor browser data. (7)

Include statement Placement within Online Elements—Placement of the include statements within the online element can be anywhere within the body of the online element.

Visitor browser collected data variable placement within online elements—Placement of the script defined variable can be appended to any document request located after the include statements within the body of the online element. This includes but not limited to images, style sheets, and scripts.

Script application and execution—The scripts that collect the visitor browser data are located on the remote data collection server. The application of the script within an online element is implemented through the use of ‘include’ statements. Through the use of include statements, the browser is instructed to execute the scripts located on the remote data collection server.

Browser Download of Online Element and Execution of Scripts—When a browser views the online element containing the script include statements, the scripts will be executed. The scripts then collect the visitor browser data through the use of java script, visual basic, and pixel based script. The types of scripts executed and in turn the types of data collected are determined by the ability and configuration within the visitor's browser.

Remote data collection server extracting and formatting—The data collected from the visitors browser is formatted into a string variable. This string variable contains the visitor browser data formatted into a single delimited string.

Originating Web Server Saves Request to Log File—When a browser requests the string variable appended document the request is logged within the web server log file. This request is logged with the delimited string built by the remote data collection server. The logged appended visitor browser data can then be analyzed and/or outputted.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A method in a computer system for collecting online visit activity by a visitor using a visitor browser to a web-site, the method comprising:
collecting visitor browser data;
collecting web server data; and
combining said visitor browser data with said web server data to create a unified log file.

2. A method in a computer system for collecting online visit activity by a visitor using a visitor browser to a web-site, the method comprising:
receiving a request for an online element by said visitor via said visitor browser;
receiving a script executed by said visitor browser within said online element;
storing said visitor browser executed script at a remote data collection server;
collecting visitor browser data from said visitor browser at said remote data collection server;
formatting said visitor browser data at said remote data collection server;
receiving a request for a document within said online element;
appending said formatted visitor browser data to said document; and
logging said document request with said appended visitor browser data.

3. The method of claim 2, further comprising:
analyzing said logged appended visitor browser data; and
outputting said logged appended visitor browser data.

4. The method of claim 2, wherein said online element is a web page or web banner.

5. The method of claim 2, wherein said logging is accomplished by an originating web server.

6. The method of claim 2, further comprising applying said script within an online element using at least one include statement.

7. The method of claim 6, wherein said formatted visitor browser data is appended to said document after said include statement in said document.

8. The method of claim 7, wherein said include statement instructs said browser to execute said script located on said remote data collection server.

9. The method of claim 2, wherein said documents are one of: images, style sheets, or scripts.

10. The method of claim 2, wherein said script collects said visitor browser data through the use of one ofjava script, visual basic, or pixel based script.

11. The method of claim 2, wherein said data collected from said visitor browser is formatted into a string variable containing said visitor browser data formatted into a single delimited string.

12. A computer-readable medium containing instructions for controlling a computer system for collecting online visit activity by a visitor using a visitor browser to a web-site, by:
receiving a request for an online element by said visitor via said visitor browser;
receiving a script executed by said visitor browser within said online element;
storing said visitor browser executed script at a remote data collection server;
collecting visitor browser data from said visitor browser at said remote data collection server;
formatting said visitor browser data at said remote data collection server;
receiving a request for a document within said online element;
appending said formatted visitor browser data to said document; and
logging said document request with said appended visitor browser data.
